(19) United States
(12) Patent Application Publication
(10) Pub. No.: US 2020/0087438 A1
(43) Pub. Date: Mar. 19, 2020

(54) POLYURETHANE FOAMS BASED ON POLYETHERCARBONATE POLYOLS

(71) Applicant: Covestro Deutschland AG, Leverkusen (DE)

(72) Inventors: Persefoni Hilken, Köln (DE); Stefan Lindner, Remscheid (DE); Hartmut Nefzger, Pulheim (DE); Rolf Albach, Köln (DE); Antje Wehlau, Leverkusen (DE)

(21) Appl. No.: 16/616,796

(22) PCT Filed: May 29, 2018
(86) PCT No.: PCT/EP2018/063985

§ 371 Date: Nov. 25, 2019

(30) Foreign Application Priority Data
Jun. 1, 2017 (EP) 17174108.5

(51) Int. Cl. C08G 18/44; C08G 18/76; C08G 18/18; C08G 18/24; C08G 18/16; C08J 9/12; C08J 9/00; C08K 5/092; C08K 5/20; C08K 5/315; C08K 5/1539; C08K 5/098

(52) U.S. Cl. CPC C08G 18/44; C08G 2101/0008; C08G 18/1808; C08G 18/244; C08G 18/165; C08J 9/125; C08J 9/0023; C08J 9/0028; C08K 5/092; C08K 5/20; C08K 5/315; C08K 5/3155; C08K 5/1539; C08K 5/098; C08G 18/7621

(57) ABSTRACT

A process for producing polyurethane foams comprising reacting an isocyanate component with a component that is reactive to isocyanates and comprises at least one polyethercarbonate polyol, wherein the reaction is performed in the presence of a component K, wherein the component K is selected from one or more compounds of the group consisting of K1 dicarbonyl compounds of the formula (II), excluding dicarbonyl compounds that are esters of mono- or polybasic carboxylic acids, (R2)x-(C═O)—(R1)n-(C═O)—(R3)y (II), K2 β-keto nitriles of the formula (III), (R5)w-(C═O)—C(H)(R4)(-CN)(III), K3 discarbonyl compounds having the formula (IV),

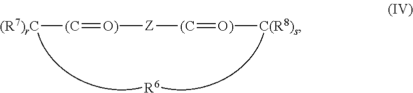

K4 hydroxycarboxylic acids, and K5 compounds of carboxylate anion and cation. Polyurethane foams produced by the process according to the present disclosure and the use thereof.

The present invention relates to a process for producing polyurethane foams, preferably flexible polyurethane foams, by reaction of an isocyanate component with a component which is reactive toward isocyanates and comprises at least one polyether carbonate polyol, with the reaction taking place in the presence of a component K which will be described in more detail below. The invention further relates to polyurethane foams produced by the process of the invention and the use thereof.

In the context of an environmentally friendly configuration of production processes, it is generally desirable to use CO₂-based starting materials, for example in the form of polyether carbonate polyols, in relatively large amounts. The preparation of polyether carbonate polyols by catalytic reaction of alkylene oxides (epoxides) and carbon dioxide in the presence of H-functional starter compounds (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown schematically in the scheme (I), where R is an organic radical such as alkyl, alkylaryl or aryl, which in each case can also contain heteroatoms such as O, S, Si, etc., and e, f and g are each an integer; the polyether carbonate polyol product shown here in scheme (I) should be interpreted merely as meaning that blocks having the structure shown can in principle recur in the polyether carbonate polyol obtained, but with the order, number and length of the blocks and also the OH functionality of the starter being able to vary and not being restricted to the polyether carbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example propylene carbonate when R=CH₃, also referred to hereinafter as cPC, or ethylene carbonate when R=H, also referred to hereinafter as cEC).

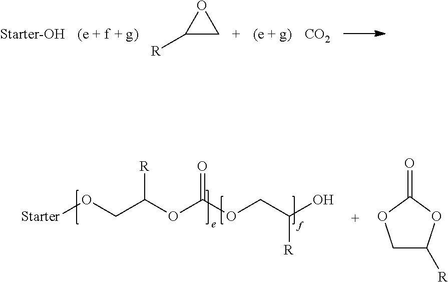

The production of polyurethane foams based on polyether carbonate polyols and isocyanates is known (e.g. WO 2012/130760 A1, EP-A 0 222 453). It has been found that when polyether carbonate polyols are used for producing polyurethane foams, the resulting products contain cyclic propylene carbonate which can be detected, for example, by emission measurements on the flexible polyurethane foam.

The patent with application number EP2016/079817 states that, through the use of esters of mono- or polybasic carboxylic acids the (first) dissociation of which has a pKa of 0.5 to 4.0 as additives in the foaming of polyurethane foams, a reduction in the emission of cyclic propylene carbonate can be observed.

It was therefore an object of the present invention to provide a process for producing polyurethane foams which leads to polyurethane foams having a reduced emission of cyclic propylene carbonate.

This object has surprisingly been achieved by a process for producing polyurethane foams, preferably flexible polyurethane foams, by reaction of
component A containing polyethercarbonate polyol having a hydroxyl number in accordance with DIN 53240-1 (June 2013) of from ≥20 mg KOH/g to ≤120 mg KOH/g (component A1) and optionally one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight (component A2), with the polyether polyols A2 being free of carbonate units,
B optionally
   B1) catalysts and/or
   B2) auxiliaries and additives
C water and/or physical blowing agents,
with
D diisocyanates and/or polyisocyanates,
where the production is effected at an index of from ≥90 to ≤120,
characterized in that the production reaction is carried out in the presence of a component K, where component K is selected from among one or more compounds from the group consisting of
K1 dicarbonyl compounds of the formula (II), excluding dicarbonyl compounds that are esters of mono- or polybasic carboxylic acids,

(R²)ₓ—(C═O)—(R¹)ₙ—(C═O)—(R³)_{y} (II)
where
n is an integer of ≥0 to ≤6, preferably ≥1 to ≤4, more preferably n=1, 2 or 4, most preferably n=1 or 2,
x, y may be the same or different and are an integer of ≥1 to ≤3, preferably 1 or 2,
R¹ may be the same or different and is substituted or unsubstituted C1-C22-alkylene, substituted or unsubstituted C1-C22-alkenylene, substituted or unsubstituted C6-C18-arylene, heteroarylene, amines or amides, or is part of a 4- to 7-membered ring or polycyclic system,
R², R³ may be the same or different and are H, substituted or unsubstituted C1-C22-alkyl, substituted or unsubstituted C1-C22-alkenyl, substituted or unsubstituted C6-C18-aryl, heteroaryl, amine, amide, hydroxyl or nitrile, or are parts of a 4- to 7-membered ring or polycyclic system,
in a preferred embodiment K1 are dicarbonyl compounds of the formula (II), excluding dicarbonyl compounds that are esters of mono- or polybasic carboxylic acids, where
n is 1, 2 or 4, preferably 1 or 2,
x, y may be the same or different and are 1 or 2,
R¹ may be the same or different and is substituted or unsubstituted C1-C22-alkylene, substituted or unsubstituted C6-C18-arylene or heteroarylene,
R², R³ may be the same or different and is substituted or unsubstituted C1-C22-alkyl, amine, amide or hydroxyl,
K2 β-keto nitriles of the formula (III)

(R⁵)_{w}—(C═O)—C(H)(R⁴)(—CN) (III)
where
w is an integer of ≥1 to ≤3, preferably 1 or 2,
R⁴ is H, substituted or unsubstituted C1-C22-alkyl, substituted or unsubstituted C1-C22-alkenyl, substituted or unsubstituted C6-C18-aryl, heteroaryl, amine or amide, or is part of a 4- to 7-membered ring or polycyclic system,
R⁵ may be the same or different and is H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or is part of a 4- to 7-membered ring or polycyclic system,
in a preferred embodiment K2 are β-keto nitriles of the formula (III) where
w is 1 or 2,
R⁴ is H,
R⁵ may be the same or different and is amine, amide or acyl,
K3 dicarbonyl compounds having the formula (IV)

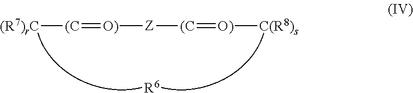

where
Z is —O—, —N(R⁹)— or C1-C6-alkylene,
r, s are 1 or 2, where
   r and s are 2 when R⁶ is a single bond, —C(R⁹)₂—, —O— or —N(R⁹)—,
   r is 1 and s is 2 when R⁶ is ═C(H)—,
   r is 2 and s is 1 when R⁶ is ═C(H)—,
   r and s are 1 when R⁶ is a double bond,
R⁶ is a single bond, double bond, —C(R⁹)₂—, ═C(H)—, —O— or —N(R⁹)—,
R⁷, R⁸ may be the same or different and is H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or are parts of a 4- to 7-membered ring or polycyclic system,
R⁹ is H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or is part of a 4- to 7-membered ring or polycyclic system,
in a preferred embodiment K3 are dicarbonyl compounds having the formula (IV) where
Z is —O— or —N(R⁹)—,
r, s are 1 or 2, where
   r and s are 2 when R⁶ is a single bond or —C(R⁹)₂—,
   r is 1 and s is 2 when R⁶ is ═C(H)—,
   r is 2 and s is 1 when R⁶ is ═C(H)—, r and s are 1 when R⁶ is a double bond,
R⁶ is a single bond, double bond, —C(R⁹)₂— or ═C(H)—,
R⁷, R⁸ may be the same or different and are H, substituted or unsubstituted C1-C22-alkyl, substituted or unsubstituted C1-C22-alkenyl, substituted or unsubstituted C6-C18-aryl, or heteroaryl, or are parts of a 4- to 7-membered ring or polycyclic system,
R⁹ is H, substituted or unsubstituted C1-C22-alkyl, substituted or unsubstituted C1-C22-alkenyl, substituted or unsubstituted C6-C18-aryl, heteroaryl or hydroxyl,
K4 hydroxycarboxylic acids, preferably α-hydroxycarboxylic acids and/or β-hydroxycarboxylic acids, more preferably α-hydroxybenzoic acid, malic acid or tartaric acid,
K5 carboxylic salts, i.e. compounds of carboxylate anion and cation, where the cation is Li⁺, Na⁺, K⁺, Rb⁺, Cs⁺, Be²⁺, Mg²⁺, Ca²⁺, Sr²⁺, Ba²⁺ or an ammonium-based compound)N(H)ₒ(R¹⁰)ₚ where o and p are an integer from 0 to 4, o+p=4 and where R¹⁰ is substituted or unsubstituted C1-C22-alkyl, substituted or unsubstituted C1-C22-alkenyl, substituted or unsubstituted C6-C18-aryl, the cation is preferably an ammonium-based compound)N(H)ₒ(R¹⁰)ₚ where o, p, R¹⁰ have the definition given above, and the cation is more preferably selected from one or more ammonium-based compounds from the group consisting of NH₄⁺, (NR¹⁰₄)⁺, (NR¹⁰₃H)⁺, where R¹⁰ has the definition given above,
and where component K is used in an amount of from ≥0.05 to ≤10.0 parts by weight, preferably from ≥0.5 to ≤6.0 parts by weight, particularly preferably ≥1.0 to ≤5.0 parts by weight, where all parts by weight of the component K are based on the sum of the parts by weight of the components A1+A2=100 parts by weight.

The invention preferably provides a process for producing polyurethane foams, preferably flexible polyurethane foams, by reaction of
A1 from ≥40 to ≤100 parts by weight, preferably from ≥60 to ≤100 parts by weight, particularly preferably from ≥80 to ≤100 parts by weight, of one or more polyether carbonate polyols having a hydroxyl number in accordance with DIN 53240-1 (June 2013) of from ≥20 mg KOH/g to ≤120 mg KOH/g,
A2 from ≤60 to ≥0 parts by weight, preferably from ≤40 to ≥0 parts by weight, particularly preferably from ≤20 to ≥0 parts by weight, of one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, where the polyether polyols A2 are free of carbonate units,
A3 from ≤20 to ≥0 parts by weight, based on the sum of the parts by weight of the components A1 and A2, of one or more polyether polyols having a hydroxyl number in accordance with DIN 53240-1 (June 2013) of from ≥20 mg KOH/g to ≤250 mg KOH/g and a content of ethylene oxide of >60% by weight, with the polyether polyols A3 being free of carbonate units,
A4 from ≤40 to ≥0 parts by weight, based on the sum of the parts by weight of the components A1 and A2, of one or more polymer polyols, PUD polyols and/or PIPA polyols,
A5 from ≤40 to ≥0 parts by weight, based on the sum of the parts by weight of the components A1 and A2, of polyols which do not come under the definition of the components A1 to A4,
B optionally
   B1) catalysts and/or
   B2) auxiliaries and additives
C water and/or physical blowing agents,
with
D diisocyanates and/or polyisocyanates,
where the production is effected at an index of from ≥90 to ≤120,
   where all percent by weight of the components A1, A2, A3, A4, A5 are normalized in such a way that the sum of the parts by weight of A1+A2 in the composition is 100, characterized in that the production takes place in the presence of component K.

The components A1 to A5 in each case relate to “one or more” of the compounds mentioned. When a plurality of compounds of one component are used, the amount indicated corresponds to the sum of the parts by weight of the compounds.

In a particularly preferred embodiment, component A contains
A1 from ≥65 to ≤75 parts by weight, most preferably from ≥68 to ≤72 parts by weight of one or more polyether carbonate polyols having a hydroxyl number according to DIN 53240-1 (June 2013) of from ≥20 mg KOH/g to ≤120 mg KOH/g and preferably a CO₂ content of from 15 to 25% by weight, and
A2 from ≤35 to ≥25 parts by weight, most preferably from ≤32 to ≥28 parts by weight, of one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, where the polyether polyols A2 are free of carbonate units,
   where the component A is preferably free of components A3 and/or A4.

In another embodiment, component A comprises
A1 from ≥65 to ≤75 parts by weight, preferably from ≥68 to ≤72 parts by weight of one or more polyether carbonate polyols having a hydroxyl number according to DIN 53240-1 (June 2013) of from ≥20 mg KOH/g to ≤120 mg KOH/g and preferably a CO₂ content of from 15 to 25% by weight, and
A2 from ≤35 to ≥25 parts by weight, preferably from ≤32 to ≥28 parts by weight, of one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, where the polyether polyols A2 are free of carbonate units,
A3 from ≤20 to ≥2 parts by weight, preferably from ≤10 to ≥2 parts by weight, based on the sum of the parts by weight of the components A1 and A2, of one or more polyether polyols having a hydroxyl number in accordance with DIN 53240-1 (June 2013) of from ≥20 mg KOH/g to ≤250 mg KOH/g and a content of ethylene oxide of ≥60% by weight, where the polyether polyols A3 are free of carbonate units,
   where the component A is preferably free of component A4.

In a further embodiment, component A comprises
A1 from ≥40 to ≤100 parts by weight, preferably from ≥60 to ≤100 parts by weight, particularly preferably from ≥80 to ≤100 parts by weight, most preferably from ≥65 to ≤75 parts by weight, of one or more polyether carbonate polyols having a hydroxyl number in accordance with DIN 53240-1 (June 2013) of from ≥20 mg KOH/g to ≤120 mg KOH/g and preferably a CO₂ content of from 15 to 25% by weight, and
A2 from ≤60 to ≥0 parts by weight, preferably from ≤40 to ≥0 parts by weight, particularly preferably from ≤20 to ≥0 parts by weight, most preferably from ≤35 to ≥25 parts by weight, of one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, where the polyether polyols A2 are free of carbonate units,
A4 from ≤40 to ≥0.01 parts by weight, preferably from ≤20 to ≥0.01 parts by weight, particularly preferably from ≤20 to ≥1 parts by weight, most preferably from ≤20 to ≥2 parts by weight, based on the sum of the parts by weight of the components A1 and A2, of one or more polymer polyols, PUD polyols and/or PIPA polyols,
A5 from ≤40 to ≥0 parts by weight, based on the sum of the parts by weight of the components A1 and A2, of polyols which do not come under the definition of the components A1 to A4,
   where the component A is preferably free of component A3.

Here, the stated ranges and ranges of preference of components A1, A2, A4, and A5 are freely combinable with one another.

In the following, the components used in the process of the invention are described in more detail.

### Component A1

The component A1 comprises a polyether carbonate polyol which has a hydroxyl number (OH number) in accordance with DIN 53240-1 (June 2013) of from ≥20 mg KOH/g to ≤120 mg KOH/g, preferably from ≥20 mg KOH/g to ≤100 mg KOH/g, particularly preferably from ≥25 mg KOH/g to ≤90 mg KOH/g, and is obtainable by copolymerization of carbon dioxide and one or more alkylene oxides in the presence of one or more H-functional starter molecules, where the polyether carbonate polyol preferably has a CO₂ content of from 15 to 25% by weight. Component A1 preferably comprises a polyether carbonate polyol which is obtainable by copolymerization of from ≥2% by weight to ≤30% by weight of carbon dioxide and from ≥70% by weight to ≤98% by weight of one or more alkylene oxides in the presence of one or more H-functional starter molecules having an average functionality of from ≥1 to ≤6, preferably from ≥1 to ≤4, particularly preferably from ≥2 to ≤3. For the purposes of the invention, the expression “H-functional” refers to a starter compound which has H atoms which are active in respect of alkoxylation.

The copolymerization of carbon dioxide and one or more alkylene oxides is preferably effected in the presence of at least one DMC catalyst (double metal cyanide catalyst).

The polyether carbonate polyols used in accordance with the invention preferably also have ether groups between the carbonate groups, shown schematically in formula (V). In the scheme according to formula (V), R is an organic radical such as alkyl, alkylaryl or aryl which can in each case also contain heteroatoms such as O, S, Si, etc.; e and f are each an integer. The polyether carbonate polyol shown in the scheme according to formula (V) should be considered to mean merely that blocks having the structure shown can in principle recur in the polyether carbonate polyol but the order, number and length of the blocks can vary and is not restricted to the polyether carbonate polyol shown in formula (V). In relation to formula (V), this means that the ratio of e/f is preferably from 2:1 to 1:20, particularly preferably from 1.5:1 to 1:10.

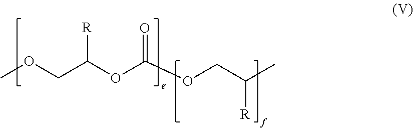

The proportion of incorporated CO₂ (“units derived from carbon dioxide”; “CO₂ content”) in a polyether carbonate polyol can be determined from the evaluation of characteristic signals in the ¹H NMR spectrum. The following example illustrates the determination of the proportion of units derived from carbon dioxide in a 1,8-octanediol-initiated CO₂/propylene oxide polyether carbonate polyol.

The proportion of incorporated CO₂ in a polyether carbonate polyol and the ratio of propylene carbonate to polyether carbonate polyol can be determined by means of ¹H NMR (a suitable instrument is the DPX 400 instrument from Bruker, 400 MHz; pulse program zg30, delay time dl: 10 s, 64 scans). Each sample is dissolved in deuterated chloroform. The relevant resonances in the ¹H NMR (based on TMS=0 ppm) are as follows:

Cyclic propylene carbonate (which was formed as a by-product) having a resonance at 4.5 ppm; carbonate resulting from carbon dioxide incorporated in the polyether carbonate polyol having resonances at 5.1 to 4.8 ppm; unreacted propylene oxide (PO) having a resonance at 2.4 ppm; polyether polyol (i.e. without incorporated carbon dioxide) having resonances at 1.2 to 1.0 ppm; the octane-1,8-diol incorporated as starter molecule (if present) having a resonance at 1.6 to 1.52 ppm.

The proportion by weight (in % by weight) of polymer-bonded carbonate (LC′) in the reaction mixture was calculated according to formula (VI)

$$LC = \frac{[ A ( 5.1 - 4.8 ) - A ( 4.5 ) ] * 102}{N} * 100 \% \qquad ( VI )$$

where the value of N (“denominator” N) is calculated according to formula (VII):

N=[A(5.1-4.8)−A(4.5)]*102+A(4.5)*102+A(2.4)*58+0.33*A(1.2-1.0)*58+0.25*A(1.6-1.52)*146 (VII)

The following abbreviations apply here:

A(4.5)=area of the resonance at 4.5 ppm for cyclic carbonate (corresponds to a hydrogen atom)
A(5.1-4.8)=area of the resonance at 5.1-4.8 ppm for polyether carbonate polyol and a hydrogen atom for cyclic carbonate
A(2.4)=area of the resonance at 2.4 ppm for free, unreacted PO
A(1.2-1.0)=area of the resonance at 1.2-1.0 ppm for polyether polyol
A(1.6-1.52)=area of the resonance at 1.6 to 1.52 ppm for octane-1,8-diol (starter), if present.

The factor of 102 results from the sum of the molar masses of CO₂ (molar mass 44 g/mol) and of propylene oxide (molar mass 58 g/mol), the factor of 58 results from the molar mass of propylene oxide, and the factor of 146 results from the molar mass of the octane-1,8-diol starter used (if present).

The proportion by weight (in % by weight) of cyclic carbonate (CC) in the reaction mixture was calculated according to formula (VIII)

$${CC}^{′} = \frac{A ( 4.5 ) * 102}{N} * 100 \% \qquad ( VIII )$$

where the value of N is calculated according to formula (VII).

In order to calculate the composition based on the polymer component (consisting of polyether polyol built up from starter and propylene oxide during the activation steps taking place under CO₂-free conditions, and polyether carbonate polyol built up from starter, propylene oxide and carbon dioxide during the activation steps taking place in the presence of CO₂ and during the copolymerization) from the values for the composition of the reaction mixture, the nonpolymeric constituents of the reaction mixture (i.e. cyclic propylene carbonate and any unreacted propylene oxide present) were eliminated mathematically. The proportion by weight of the repeat carbonate units in the polyether carbonate polyol was converted to a proportion by weight of carbon dioxide using the factor F=44/(44+58). The indicated CO₂ content in the polyether carbonate polyol is normalized relative to the proportion of the polyether carbonate polyol molecule formed in the copolymerization and any activation steps in the presence of CO₂ (i.e. the proportion of the polyether carbonate polyol molecule resulting from the starter (1,8-octanediol, if present) and from the reaction of the starter with epoxide added under CO₂-free conditions was disregarded here).

For example, the production of polyether carbonate polyols according to A1 comprises by:

(α) initially charging an H-functional starter compound or a mixture of at least two H-functional starter compounds and optionally removing water and/or other volatile compounds by means of elevated temperature and/or reduced pressure (“drying”), with the DMC catalyst being added to the H-functional starter compound or the mixture of at least two H-functional starter compounds before or after drying,
(β) adding a partial amount (based on the total amount of the amount of alkylene oxides used in the activation and copolymerization) of one or more alkylene oxides to the mixture resulting from step (α) to effect the activation, with this addition of a partial amount of alkylene oxide optionally being able to be carried out in the presence of CO₂ and the hot spots occurring as a result of the subsequent exothermic chemical reaction and/or a pressure drop in the reactor then being awaited and the activation step (β) also being able to be carried out a number of times,
(γ) adding one or more of the alkylene oxides and carbon dioxide to the mixture resulting from step (β), with the alkylene oxides used in step (β) being able to be identical to or different from the alkylene oxides used in step (y).

In general, alkylene oxides (epoxides) having 2 to 24 carbon atoms can be used for preparing the polyether carbonate polyols A1. The alkylene oxides having from 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxidized or polyepoxidized fats as monoglycerides, diglycerides and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preference is given to using ethylene oxide and/or propylene oxide and/or 1,2-butylene oxide, particularly preferably propylene oxide, as alkylene oxides.

In a preferred embodiment of the invention, the proportion of ethylene oxide in the total amount of propylene oxide and ethylene oxide used is from ≥0 to ≤90% by weight, preferably from ≥0 to ≤50% by weight, and is particularly preferably free of ethylene oxide.

As suitable H-functional starter compounds, it is possible to use compounds having H atoms which are active in respect of alkoxylation. Groups active in respect of the alkoxylation and having active hydrogen atoms are, for example, —OH, —NH₂ (primary amines), —NH— (secondary amines), SH, and —CO₂H, preferably —OH and —NH₂, more preferably —OH. As H-functional starter compounds, use is made of, for example, one or more compounds selected from the group consisting of water, mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, poly etheramines (e.g. Jeffamines® from Huntsman, e.g. D-230, D-400, D 2000, T-403, T-3000, T-5000, or corresponding products from BASF, e.g. polyetheramine D230, D400, D200, T403, T5000), polytetrahydrofurans (e.g. PolyTHF® from BASF, e.g. PolyTHF® 250, 650S, 1000, 10005, 1400, 1800, 2000), polytetrahydrofuranamines (BASF product polytetrahydrofuranamine 1700), polyether thiols, polyacrylate polyols, castor oil, the monoglyceride or diglyceride of ricinoleic acid, monoglycerides of fatty acids, chemically modified monoglycerides, diglycerides and/or triglycerides of fatty acids, and C1-C24-alkyl fatty acid esters containing an average of at least 2 OH groups per molecule. By way of example, the C1-C24-alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Monofunctional starter compounds used may be alcohols, amines, thiols and carboxylic acids. Monofunctional alcohols used may be: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, t-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols with suitability as H-functional starter compounds are, for example, dihydric alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentantanediol, methylpentanediols (such as, for example, 3-methyl-L5-pentanediol), 1,6-hexanediol; 1,8-octanediol, 1,10-decanediol, 1,12-dodecanediol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil), and also all products of modification of these aforementioned alcohols with different amounts of ε-caprolactone. In mixtures of H-functional starters, it is also possible to use trihydric alcohols, for example trimethylolpropane, glycerol, trishydroxyethyl isocyanurate and castor oil.

The H-functional starter compounds can also be selected from the class of polyether polyols, in particular those having a molecular weight Mₙ in the range from 100 to 4000 g/mol, preferably from 250 to 2000 g/mol. Preference is given to polyether polyols formed from repeat ethylene oxide and propylene oxide units, preferably having a proportion of propylene oxide units of 35% to 100%, particularly preferably having a proportion of propylene oxide units of 50% to 100%. These may be random copolymers, gradient copolymers, alternating copolymers or block copolymers of ethylene oxide and propylene oxide. Suitable polyether polyols made up of repeating propylene oxide and/or ethylene oxide units are for example, the Desmophen®, Acclaim®, Arcol®, Baycoll®, Bayfill®, Bayflex®, Baygal®, PET® and polyether polyols from Covestro Deutschland AG (for example Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriol® E products from BASF SE, suitable homopolypropylene oxides are, for example, the Pluriol® P products from BASF SE; suitable mixed copolymers of ethylene oxide and propylene oxide are, for example, the Pluronic® PE or Pluriol® RPE products from BASF SE.

The H-functional starter compounds can also be selected from the class of polyester polyols, in particular those having a molecular weight Mₙ in the range from 200 to 4500 g/mol, preferably from 400 to 2500 g/mol. The polyester polyols used are at least difunctional polyesters. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Using dihydric or polyhydric polyether polyols as alcohol components gives polyester ether polyols which can likewise serve as starter compounds for preparing the polyether carbonate polyols. If polyether polyols are used to prepare the polyester ether polyols, preference is given to polyether polyols having a number-average molecular weight Mₙ of 150 to 2000 g/mol.

In addition, the H-functional starter compounds used may be polycarbonate polyols (for example polycarbonate diols), especially those having a molecular weight Mₙ in the range from 150 to 4500 g/mol, preferably 500 to 2500, which are prepared, for example, by reaction of phosgene, dimethyl carbonate, diethyl carbonate or diphenyl carbonate and di- and/or polyfunctional alcohols or polyester polyols or polyether polyols. Examples of polycarbonate polyols may be found in EP-A 1359177 for example. For example, the Desmophen® C grades from Covestro Deutschland AG, e.g. Desmophen® C 1100 or Desmophen® C 2200, can be used as polycarbonate diols.

It is likewise possible to use polyether carbonate polyols as H-functional starter compounds. In particular, polyether carbonate polyols prepared by the above-described process are used. For this purpose, these polyether carbonate polyols used as H-functional starter compounds are prepared in a separate reaction step beforehand.

Preferred H-functional starter compounds are alcohols of the general formula (IX)

HO—(CH₂)ₓ—OH (IX)

where x is a number from 1 to 20, preferably an even number from 2 to 20. Examples of alcohols of formula (IX) are ethylene glycol, butane-1,4-diol, hexane-1,6-diol, octane-1,8-diol, decane-1,10-diol and dodecane-1,12-diol. Further preferred H-functional starter compounds are neopentyl glycol, trimethylolpropane, glycerol, pentaerythritol, reaction products of the alcohols of formula (IX) with ε-caprolactone, for example reaction products of trimethylolpropane with ε-caprolactone, reaction products of glycerol with ε-caprolactone and reaction products of pentaerythritol with ε-caprolactone. Preference is also given to using water, diethylene glycol, dipropylene glycol, castor oil, sorbitol and polyether polyols made up of repeating polyalkylene oxide units as H-functional starter compounds.

More preferably, the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have a number-average molecular weight Mₙ in the range from 62 to 4500 g/mol and in particular a number average molecular weight Mₙ in the range from 62 to 3000 g/mol, very particularly preferably a molecular weight of from 62 to 1500 g/mol. The polyether polyols preferably have a functionality of from ≥2 to ≤3.

In a preferred embodiment of the invention, the polyether carbonate polyol A1 is obtainable by addition of carbon dioxide and alkylene oxides onto H-functional starter compounds using multimetal cyanide catalysts (DMC catalysts). The preparation of polyether carbonate polyols by addition of alkylene oxides and CO₂ onto H-functional starter compounds using DMC catalysts is known, for example, from EP-A 0222453, WO-A 2008/013731 and EP-A 2115032.

DMC catalysts are known in principle from the prior art for homopolymerization of epoxides (see, for example, U.S. Pat. Nos. 3,404,109, 3,829,505, 3,941,849 and 5,158,922). DMC catalysts which are described, for example, in U.S. Pat. No. 5,470,813, EP-A 700 949, EP-A 743 093, EP-A 761 708, WO-A 97/40086, WO-A 98/16310 and WO-A 00/47649 have a very high activity in the homopolymerization of epoxides and make it possible to prepare polyether polyols and/or polyether carbonate polyols at very low catalyst concentrations (25 ppm or less). A typical example is the highly active DMC catalysts described in EP-A 700 949 which in addition to a double metal cyanide compound (e.g., zinc hexacyanocobaltate (III)) and an organic complexing ligand (e.g., t-butanol) contain a polyether having a number-average molecular weight Mₙ of greater than 500 g/mol.

The DMC catalyst is usually used in an amount of ≤1% by weight, preferably in an amount of ≤0.5% by weight, more preferably in an amount of ≤500 ppm and especially in an amount of ≤300 ppm, based in each case on the weight of the polyether carbonate polyol.

In a preferred embodiment of the invention, the polyether carbonate polyol A1 has a content of carbonate groups (“units derived from carbon dioxide”), calculated as CO₂, of from ≥2.0 to ≤30.0% by weight, preferably from ≥5.0 to ≤28.0% by weight and particularly preferably from ≥10.0 to ≤25.0% by weight.

In a further embodiment of the process of the invention, the polyether carbonate polyol(s) A1 has/have a hydroxyl number of from ≥20 mg KOH/g to ≤250 mg KOH/g and is/are obtainable by copolymerization of from ≥2.0% by weight to ≤30.0% by weight of carbon dioxide and from ≥70% by weight to ≤98% by weight of propylene oxide in the presence of a hydroxy-functional starter molecule, for example trimethylolpropane and/or glycerol and/or propylene glycol and/or sorbitol. The hydroxyl number can be determined in accordance with DIN 53240-1 (June 2013).

In a further embodiment, use is made of a polyether carbonate polyol A1 containing blocks of formula (V), where the ratio e/f is from 2:1 to 1:20.

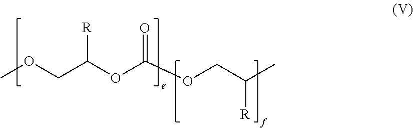

In a further embodiment of the invention, component A1 is used to an extent of 100 parts by weight.

### Component A2

Component A2 comprises polyether polyols having a hydroxyl number according to DIN 53240-1 (June 2013) of ≥20 mg KOH/g to ≤250 mg KOH/g, preferably of ≥20 to ≤112 mg KOH/g and particularly preferably ≥20 mg KOH/g to ≤80 mg KOH/g and is free from carbonate units. The compounds according to A2 may be prepared by catalytic addition of one or more alkylene oxides onto H-functional starter compounds.

Alkylene oxides (epoxides) used may be alkylene oxides having 2 to 24 carbon atoms. The alkylene oxides having from 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, monoepoxidized or polyepoxidized fats as monoglycerides, diglycerides and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, glycidyloxypropyltriethoxysilane, glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preference is given to using ethylene oxide and/or propylene oxide and/or 1,2-butylene oxide as alkylene oxides. Particular preference is given to using an excess of propylene oxide and/or 1,2-butylene oxide. The alkylene oxides can be supplied to the reaction mixture individually, in a mixture or successively. The copolymers may be random or block copolymers. If the alkylene oxides are metered in successively, the products (polyether polyols) produced contain polyether chains having block structures.

The H-functional starter compounds have functionalities of from ≥2 to ≤6 and are preferably hydroxy-functional (OH-functional). Examples of hydroxy-functional starter compounds are propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol-containing condensates of formaldehyde and phenol or melamine or urea. It is also possible to use these as mixtures. Preference is given to using 1,2-propylene glycol and/or glycerol and/or trimethylolpropane and/or sorbitol as starter compound.

The polyether polyols A2 have a content of from ≥0 to ≤60% by weight, preferably from ≥0 to ≤40% by weight, particularly preferably from ≥0 to ≤25% by weight of ethylene oxide.

### Component A3

The component A3 comprises polyether polyols having a hydroxyl number in accordance with DIN 53240-1 (June 2013) of from ≥20 mg KOH/g to ≤250 mg KOH/g, preferably from ≥20 to ≤112 mg KOH/g and particularly preferably from ≥20 mg KOH/g to ≤80 mg KOH/g.

Component A3 is in principle prepared in a manner analogous to that of the component A2, but with a content of ethylene oxide in the polyether polyol of >60% by weight, preferably ≥65% by weight, being set.

Possible alkylene oxides and H-functional starter compounds are the same as those described for component A2.

However, preference is given to H-functional starter compounds which have a functionality of from ≥3 to ≤6, particularly preferably 3, so that polyether triols are formed. Preferred starter compounds having a functionality of 3 are glycerol and/or trimethylolpropane, with particular preference being given to glycerol.

In a preferred embodiment, the component A3 is a glycerol-initiated trifunctional polyether having an ethylene oxide content of from 68 to 73% by weight and an OH number of from 35 to 40 mg KOH/g.

### Component A4

The component A4 comprises polymer polyols, PUD polyols and PIPA polyols.

Polymer polyols are polyols which contain proportions of solid polymers produced by free-radical polymerization of suitable monomers such as styrene or acrylonitrile in a base polyol, e.g. a polyether polyol and/or polyether carbonate polyol.

PUD (polyurea dispersion) polyols are, for example, prepared by in-situ polymerization of an isocyanate or an isocyanate mixture with a diamine and/or hydrazine in a polyol, preferably a polyether polyol. The PUD dispersion is preferably prepared by reaction of an isocyanate mixture used from a mixture composed of from 75 to 85% by weight of tolylene 2,4-diisocyanate (2,4-TDI) and from 15 to 25% by weight of tolylene 2,6-diisocyanate (2,6-TDI) with a diamine and/or hydrazine in a polyether polyol, preferably a polyether polyol and/or polyether carbonate polyol prepared by alkoxylation of a trifunctional starter (for example glycerol and/or trimethylolpropane), in the case of the polyether carbonate polyol in the presence of carbon dioxide. Processes for preparing PUD dispersions are described, for example, in U.S. Pat. Nos. 4,089,835 and 4,260,530.

The PIPA polyols are polyether polyols and/or polyether carbonate polyols modified with alkanolamines, preferably modified with triethanolamine, by polyisocyanate-polyaddition, where the polyether (carbonate) polyol has a functionality of from 2.5 to 4 and a hydroxyl number of from ≥3 mg KOH/g to ≤112 mg KOH/g (molecular weight from 500 to 18 000). The polyether polyol is preferably “EO capped”, i.e. the polyether polyol has terminal ethylene oxide groups. PIPA polyols are described in detail in GB 2 072 204 A, DE 31 03 757 A1 and U.S. Pat. No. 4,374,209 A.

### Component A5

As component A5, it is possible to use all polyhydroxy compounds known to those skilled in the art which do not come under the definition of the components A1 to A4, and preferably have an average OH functionality of >1.5.

These may be, for example, low molecular weight diols (e.g. ethane-1,2-diol, propane-1,3- or -1,2-diol, butane-1,4-diol), triols (e.g. glycerol, trimethylolpropane) and tetraols (e.g. pentaerythritol), polyester polyols, polythioether polyols or polyacrylate polyols or else polyether polyols or polycarbonate polyols which do not come under the definition of components A1 to A4. It is also possible to use, for example, ethylenediamine- and triethanolamine-initiated polyethers. These compounds are not counted as compounds according to the definition of component B2.

### Component B

As catalysts of the component B1, preference is given to using
a) aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethyl(bisaminoethyl ether)), cycloaliphatic amino ethers (for example N-ethylmorpholine), aliphatic amidines, cycloaliphatic amidines, urea and derivatives of urea (for example aminoalkylureas, see, for example, EP-A 0 176 013, in particular (3-dimethylaminopropylamino)urea) and/or
b) tin(II) salts of carboxylic acids.

In particular, the tin(II) salts of carboxylic acids are used, with the parent carboxylic acid in each case having from 2 to 24 carbon atoms. For example, one or more compounds selected from the group consisting of the tin(II) salt of 2-ethylhexanoic acid (i.e. tin(II) 2-ethylhexanoate or tin octoate), the tin(II) salt of 2-butyloctanoic acid, the tin(II) salt of 2-hexyldecanoic acid, the tin(II) salt of neodecanoic acid, the tin(II) salt of isononanoic acid, the tin(II) salt of oleic acid, the tin(II) salt of ricinoleic acid and tin(II) laurate are used as tin(II) salts of carboxylic acids.

In a preferred embodiment of the invention, at least one tin(II) salt of the formula (X)

Sn(CₓH₂ₓ₊₁COO)₂ (X)

where x is an integer from 8 to 24, preferably from 10 to 20, particularly preferably from 12 to 18, is used. In formula (X), the alkyl chain CₓH₂ₓ₊₁ of the carboxylate is particularly preferably a branched carbon chain, i.e. CₓH₂ₓ₊₁ is an iso-alkyl group.

One or more compounds selected from the group consisting of the tin(II) salt of 2-butyloctanoic acid, i.e. tin(II) 2-butyloctoate, the tin(II) salt of ricinoleic acid, i.e. tin(II) ricinoleate, and the tin(II) salt of 2-hexyldecanoic acid, i.e. tin(II) 2-hexyldecanoate, are most preferably used as tin(II) salts of carboxylic acids.

In another preferred embodiment of the invention, the component B1 used is composed of
B1.1 from ≥0.05 to ≤1.5 parts by weight, based on the sum of the parts by weight of the components A1 and A2, of urea and/or derivatives of urea and
B1.2 from ≥0.03 to ≤1.5 parts by weight, based on the sum of the parts by weight of components A1 and A2, of catalysts other than those of the component B1.2, with the content of amine catalysts in the component B1.2 being not more than 50% by weight based on component B1.

Component B1.1 comprises urea and derivatives of urea. Examples of derivatives of urea are: aminoalkylureas, e.g. (3-dimethylaminopropylamine)urea and 1,3-bis[3-(dimethylamino)propyl]urea. It is also possible to use mixtures of urea and urea derivatives. Preference is given to using exclusively urea in component B1.1. Component B1.1 is used in amounts of from ≥0.05 to ≤1.5 parts by weight, preferably from ≥0.1 to ≤0.5 parts by weight, particularly preferably from ≥0.25 to ≤0.35 parts by weight, based on the sum of the parts by weight of the components A1 to A2.

Component B1.2 is used in amounts of from ≥0.03 to ≤1.5 parts by weight, preferably from ≥0.03 to ≤0.5 parts by weight, particularly preferably from ≥0.1 to ≤0.3 parts by weight, very particularly preferably from ≥0.2 to ≤0.3 parts by weight, based on the sum of the parts by weight of the components A1 to A2.

The content of amine catalysts in the component B1.2 is preferably not more than 50% by weight based on component B1.1, particularly preferably not more than 25% by weight based on component B1.1. Component B1.2 is very particularly preferably free of amine catalysts. The above-described tin(II) salts of carboxylic acids, for example, can be used as catalysts of the component B1.2.

As amine catalysts which may be concomitantly used in small amounts (see above), mention may be made of: aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bisdimethylaminoethyl ether, 2-(2-dimethylaminoethoxy)ethanol and N,N,N-trimethyl-N-hydroxy ethyl(bisaminoethyl ether)), cycloaliphatic amino ethers (for example N-ethylmorpholine), aliphatic amidines and cycloaliphatic amidines

The “amine catalysts” specified in B1.2 do not include urea or derivatives thereof.

The invention therefore also provides a process for producing polyurethane foams, characterized in that
component A containing polyether carbonate polyol having a hydroxyl number in accordance with DIN 53240 of from ≥20 mg KOH/g to ≤120 mg KOH/g (component A1),
is reacted in nonalkaline medium with
C water and/or physical blowing agents and
D diisocyanates and/or polyisocyanates,
where the production reaction is carried out at an index of from ≥90 to ≤120,
characterized in that the production takes place in the presence of component K.

The nonalkaline medium can preferably be achieved by using urea and/or derivatives of urea as catalysts of component B1 and not using any amine catalysts.

The invention therefore preferably provides a process for producing polyurethane foams, characterized in that
A1 one or more polyether carbonate polyols having a hydroxyl number in accordance with DIN 53240-1 (June 2013) of from ≥20 mg KOH/g to ≤120 mg KOH/g,
B1 in the presence of urea and/or derivatives of urea and in the absence of amine catalysts are reacted with
C water and/or physical blowing agents and
D diisocyanates and/or polyisocyanates,
   in nonalkaline medium, with the production reaction being carried out at an index of from ≥90 to ≤120,
   characterized in that the production takes place in the presence of component K.

As component B2, use is made of auxiliaries and additives such as
a) surface-active additives such as emulsifiers and foam stabilizers, in particular ones having low emission, for example products of the Tegostab® LF2 series,
b) additives such as reaction retarders (e.g. acidic substances such as hydrochloric acid or organic acid halides), cell regulators (for example paraffins or fatty alcohols or dimethylpolysiloxanes), pigments, dyes, flame retardants (different from component K3; for example ammonia polyphosphate), further stabilizers against aging and weathering influences, antioxidants, plasticizers, fungistatic and bacteriostatic substances, fillers (for example barium sulfate, kieselguhr, carbaneous chalk or prepared chalk) and separating agents.

These auxiliaries and additives for optional additional use are described, for example, in EP-A 0 000 389, pages 18-21. Further examples of auxiliaries and additives which may be concomitantly used according to the invention and details regarding the use and mode of action of these auxiliaries and additives are described in Kunststoff-Handbuch, volume VII, edited by G. Oertel, Carl-Hanser-Verlag, Munich, 3rd edition, 1993, e.g. on pages 104-127.

### Component C

Water and/or physical blowing agents are used as component C. Physical blowing agents used as blowing agents are, for example, carbon dioxide and/or volatile organic substances. Preference is given to using water as component C.

### Component D

Suitable di- and/or polyisocyanates are aliphatic, cycloaliphatic, araliphatic, aromatic and heterocyclic polyisocyanates, as are described, for example, by W. Siefken in Justus Liebigs Annalen der Chemie, 562, pages 75 to 136, for example those of the formula (XI)

Q(NCO)ₙ (XI)

in which
n=2-4, preferably 2-3,
and
Q is an aliphatic hydrocarbon radical having 2-18, preferably 6-10, carbon atoms, a cycloaliphatic hydrocarbon radical having 4-15, preferably 6-13, carbon atoms or an araliphatic hydrocarbon radical having 8-15, preferably 8-13, carbon atoms.

For example, the polyisocyanates are those as described in EP-A 0 007 502, pages 7-8. Preference is generally given to the readily industrially obtainable polyisocyanates, for example tolylene 2,4- and 2,6-diisocyanate and any desired mixtures of these isomers (“TDI”); polyphenylpolymethylene polyisocyanates as prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially those modified polyisocyanates which are derived from tolylene 2,4- and/or 2,6-diisocyanate or from diphenylmethane 4,4′- and/or 2,4′-diisocyanate. Preference is given to using one or more compounds selected from the group consisting of tolylene 2,4- and 2,6-diisocyanate, diphenylmethane 4,4′- and 2,4′- and 2,2′-diisocyanate and polyphenyl polymethylene polyisocyanate (“multiring MDI”) as polyisocyanate. Particular preference is given to using tolylene 2,4- and/or 2,6-diisocyanate.

In a further embodiment of the process of the invention, the isocyanate component D comprises a tolylene diisocyanate isomer mixture composed of from 55 to 90% by weight of 2,4-TDI and from 10 to 45% by weight of 2,6-TDI.

In a further embodiment of the process of the invention, the isocyanate component D comprises 100% by weight of tolylene 2,4-diisocyanate.

In one embodiment of the process of the invention, the index is from ≥90 to ≤120. The index is preferably in a range from ≥100 to ≤115, particularly preferably from ≥102 to ≤110. The index indicates the percentage ratio of the amount of isocyanate actually used to the stoichiometric amount, i.e. the amount calculated for reaction of the OH equivalents, of isocyanate groups (NCO).

Index=(amount of isocyanate used):(amount of isocyanate calculated)·100 (XII)

### Component K

Component K is selected from one or more compounds of the group consisting of the components K1, K2, K3, K4 and K5, which are described below.

### Component K1

Examples of compounds that can be used as component K1 are succinic acid, thiophene-2,5-dicarboxylic acid, malonamide, acetoacetamide, N,N-dimethylacetoacetamide, acetylacetone, 5,5-dimethyl-1,3-cyclohexanedione, terephthalic acid, oxalamide, diacetylhydrazine, adipic acid, maleic acid or citraconic acid, preference being given in accordance with the invention to using malonamide or thiophene-2,5-dicarboxylic acid.

### Component K2

Examples of compounds that can be used as component K2 are cyanoacetohydrazide, N-benzyl-2-cyanoacetamide, cyanoacetamide, 2-amino-2-cyanoacetamide, N-tert-butyl-2-cyanoacetamide or cyanoacetylurea, preference being given in accordance with the invention to using cyanoacetamide and cyanoacetylurea.

### Component K3

Components K3 used may, for example, be phthalic anhydride, 1,2,3,6-tetrahydrophthalic anhydride, dodecenylsuccinic anhydride, citraconic anhydride, glutaric anhydride or N-hydroxyphthalimide, preference being given to using dodecenylsuccinic anhydride, N-hydroxyphthalimide, glutaric anhydride or 1,2,3,6-tetrahydrophthalic anhydride, most preferably dodecenylsuccinic anhydride, 1,2,3,6-tetrahydrophthalic anhydride or N-hydroxyphthalimide.

### Component K4

Components K4 used are preferably α-hydroxycarboxylic acids, β-hydroxycarboxylic acids or substituted and unsubstituted and hydroxybenzoic acid, for example salicylic acid, malic acid, tartaric acid, 5-sulfosalicylic acid, 3-hydroxybenzoic acid, or 3-hydroxypropionic acid, particular preference being given to using salicylic acid, malic acid or tartaric acid.

### Component K5

Component K5 is selected from one or more compounds of the carboxylic salts. Preferably, the anionic moiety of the salt, i.e. the carboxylate ion, consists of singly or multiply deprotonated carboxylic acid. It is possible to use, for example, singly or multiply deprotonated carboxylic acids, especially those based on maleic acid, malonic acid, tartaric acid, acetic acid, benzoic acid, adipic acid, malic acid and/or oxalic acid.

Components K5 used may, for example, be ammonium tartrate, sodium acetate, sodium cyanoacetate, sodium adipate, calcium adipate or calcium oxalate, preferably ammonium tartrate, sodium cyanoacetate and sodium adipate, most preferably ammonium tartrate and/or sodium cyanoacetate.

Component K can be used in an amount of from ≥0.05 to ≤10.0 parts by weight, preferably from ≥0.5 to ≤6.0 parts by weight, particularly preferably from ≥1.0 to ≤5.0 parts by weight, where the parts by weight of the component K are based on the sum of the parts by weight of the components A1+A2=100 parts by weight. It has been found that an excessive amount of component K influences the mechanical properties of the flexible foam compared to the zero value (without component K) to an undesirable extent. For economic reasons as well, higher contents of component K tend to be disadvantageous.

To produce the polyurethane foams, the reaction components are reacted by the single-step process known per se, often with the aid of mechanical devices, e.g. those described in EP-A 355 000. Details of processing apparatuses which are also suitable in accordance with the invention are described in Kunststoff-Handbuch, volume VII, edited by Vieweg and Hochtlen, Carl-Hanser-Verlag, Munich 1993, for example on pages 139 to 265.

The polyurethane foams are preferably in the form of flexible polyurethane foams and may be produced as molded foams or else as slabstock foams, preferably as slabstock foams. The invention therefore provides a process for producing the polyurethane foams, the polyurethane foams produced by these processes, the flexible polyurethane slabstock foams/flexible polyurethane molded foams produced by these processes, the use of the flexible polyurethane foams for production of moldings, and the moldings themselves.

The polyurethane foams, preferably flexible polyurethane foams, obtainable according to the invention are employed, for example, in the following applications: furniture upholstery, textile inserts, mattresses, automobile seats, headrests, armrests, sponges, foam sheets for use in automobile components such as roof liners, door trim, seat cushions and components.

The flexible foams of the invention have a foam density in accordance with DIN EN ISO 3386-1-98 in the range from ≥16 to ≤60 kg/m³, preferably from ≥20 to ≤50 kg/m³.

In a first embodiment, the invention accordingly provides a process for producing polyurethane foams by reaction of
component A containing polyethercarbonate polyol having a hydroxyl number in accordance with DIN 53240-1 (June 2013) of from ≥20 mg KOH/g to ≤120 mg KOH/g (component A1) and optionally one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight (component A2), with the polyether polyols A2 being free of carbonate units,
B optionally
   B1) catalysts, and/or
   B2) auxiliaries and additives
C water and/or physical blowing agents,
with
D diisocyanates and/or polyisocyanates,
where the production is effected at an index of from ≥90 to ≤120,
characterized in that the production reaction is effected in the presence of a component K, where component K is selected from one or more compounds from the group consisting of
K1 dicarbonyl compounds of the formula (II), excluding dicarbonyl compounds that are esters of mono- or polybasic carboxylic acids,

(R²)ₓ—(C═O)—(R¹)ₙ—(C═O)—(R³)_{y} (II)
where
n is an integer of ≥0 to ≤6, preferably ≥1 to ≤4, more preferably n=1, 2 or 4, most preferably n=1 or 2,
x, y may be the same or different and are an integer of ≥1 to ≤3, preferably 1 or 2,
R¹ may be the same or different and is substituted or unsubstituted C1-C22-alkylene, substituted or unsubstituted C1-C22-alkenylene, substituted or unsubstituted C6-C18-arylene, heteroarylene, amines or amides, or is part of a 4- to 7-membered ring or polycyclic system,
R², R³ may be the same or different and are H, substituted or unsubstituted C1-C22-alkyl, substituted or unsubstituted C1-C22-alkenyl, substituted or unsubstituted C6-C18-aryl, heteroaryl, amine, amide, hydroxyl or nitrile, or are parts of a 4- to 7-membered ring or polycyclic system,
in a preferred embodiment K1 are dicarbonyl compounds of the formula (II), excluding dicarbonyl compounds that are esters of mono- or polybasic carboxylic acids, where
n is 1, 2 or 4, preferably 1 or 2,
x, y may be the same or different and are 1 or 2,
R¹ may be the same or different and is substituted or unsubstituted C1-C22-alkylene, substituted or unsubstituted C6-C18-arylene or heteroarylene,
R², R³ may be the same or different and are substituted or unsubstituted C1-C22-alkyl, amine, amide or hydroxyl,
K2 β-keto nitriles of the formula (III)

(R⁵)_{w}—(C═O)—C(H)(R⁴)(—CN) (III)
where
w is an integer of ≥1 to ≤3, preferably 1 or 2,
R⁴ is H, substituted or unsubstituted C1-C22-alkyl, substituted or unsubstituted C1-C22-alkenyl, substituted or unsubstituted C6-C18-aryl, heteroaryl, amine or amide, or is part of a 4- to 7-membered ring or polycyclic system,
R⁵ may be the same or different and is H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or is part of a 4- to 7-membered ring or polycyclic system,
in a preferred embodiment K2 are β-keto nitriles of the formula (III) where
w is 1 or 2,
R⁴ is H,
R⁵ may be the same or different and is amine, amide or acyl,
K3 dicarbonyl compounds having the formula (IV)

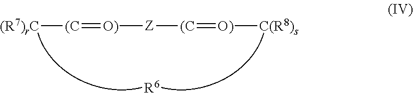

where
Z is —O—, —N(R⁹)— or C1-C6-alkylene,
r, s are 1 or 2, where
   r and s are 2 when R⁶ is a single bond, —C(R⁹)₂—, —O— or —N(R⁹)—,
   r is 1 and s is 2 when R⁶ is ═C(H)—,
   r is 2 and s is 1 when R⁶ is ═C(H)—,
   r and s are 1 when R⁶ is a double bond,
R⁶ is a single bond, double bond, —C(R⁹)₂—, ═C(H)—, —O— or —N(R⁹)—,
R⁷, R⁸ may be the same or different and are H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or are parts of a 4- to 7-membered ring or polycyclic system,
R⁹ is H, substituted or unsubstituted C1-C22-alkyl, substituted or unsubstituted C1-C22-alkenyl, substituted or unsubstituted C6-C18-aryl, heteroaryl or hydroxyl,
in a preferred embodiment K3 are dicarbonyl compounds having the formula (IV) where
Z is —O— or —N(R⁹)—,
r, s are 1 or 2, where
   r and s are 2 when R⁶ is a single bond or —C(R⁹)₂—,
   r is 1 and s is 2 when R⁶ is ═C(H)—,
   r is 2 and s is 1 when R⁶ is ═C(H)—,
   r and s are 1 when R⁶ is a double bond,
R⁶ is a single bond, double bond, —C(R⁹)₂— or ═C(H)—,
R⁷, R⁸ may be the same or different and are H, substituted or unsubstituted C1-C22-alkyl, substituted or unsubstituted C1-C22-alkenyl, substituted or unsubstituted C6-C18-aryl, or heteroaryl, or are parts of a 4- to 7-membered ring or polycyclic system,
R⁹ is H, substituted or unsubstituted C1-C22-alkyl, substituted or unsubstituted C1-C22-alkenyl, substituted or unsubstituted C6-C18-aryl, heteroaryl or hydroxyl,
K4 hydroxycarboxylic acids, preferably α-hydroxycarboxylic acids and/or β-hydroxycarboxylic acids, more preferably α-hydroxybenzoic acid, malic acid or tartaric acid,
K5 carboxylic salts, i.e. compounds of carboxylate anion and cation, where the cation is Li⁺, Na⁺, K⁺, Rb⁺, Cs⁺, Be²⁺, Mg²⁺, Ca²⁺, Sr²⁺, Ba²⁺ or an ammonium-based compound)N(H)ₒ(R¹⁰)ₚ where o and p are an integer from 0 to 4, o+p=4 and where R¹⁰ is substituted or unsubstituted C1-C22-alkyl, substituted or unsubstituted C1-C22-alkenyl, substituted or unsubstituted C6-C18-aryl, the cation is preferably an ammonium-based compound)N(H)ₒ(R¹⁰)ₚ where o, p, R¹⁰ have the definition given above, and the cation is more preferably selected from one or more ammonium-based compounds from the group consisting of NH₄⁺, (NR¹⁰₄)⁺, (NR¹⁰₃H)⁺, where R¹⁰ has the definition given above,
and where component K is used in an amount of from ≥0.05 to ≤10.0 parts by weight, preferably from ≥0.5 to ≤6.0 parts by weight, particularly preferably ≥1.0 to ≤5.0 parts by weight, where all parts by weight of the component K are based on the sum of the parts by weight of the components A1+A2=100 parts by weight.

In a second embodiment, the invention provides a process according to the first embodiment, wherein component A has the following composition:
A1 from ≥40 to ≤100 parts by weight of one or more polyether carbonate polyols having a hydroxyl number in accordance with DIN 53240-1 (June 2013) of from ≥20 mg KOH/g to ≤120 mg KOH/g,
A2 from ≤60 to ≥0 parts by weight of one or more polyether polyols having a hydroxyl number in accordance with DIN 53240 of from ≥20 mg KOH/g to ≤250 mg KOH/g and a content of ethylene oxide of from ≥0 to ≤60% by weight, with the polyether polyols A2 being free of carbonate units,
A3 from ≤20 to ≥0 parts by weight, based on the sum of the parts by weight of the components A1 and A2, of one or more polyether polyols having a hydroxyl number in accordance with DIN 53240-1 (June 2013) of from ≥20 mg KOH/g to ≤250 mg KOH/g and a content of ethylene oxide of >60% by weight, with the polyether polyols A3 being free of carbonate units,
A4 from ≤40 to ≥0 parts by weight, based on the sum of the parts by weight of the components A1 and A2, of one or more polymer polyols, PUD polyols and/or PIPA polyols,
A5 from ≤40 to ≥0 parts by weight, based on the sum of the parts by weight of the components A1 and A2, of polyols which do not come under the definition of the components A1 to A4,
where all parts by weight of the components A1, A2, A3, A4, A5 are normalized so that the sum of the parts by weight of A1+A2 in the composition is 100.

In a third embodiment, the invention provides a process according to the first or second embodiment, wherein component K is used in an amount of from ≥0.05 to ≤10.0 parts by weight, preferably from ≥0.5 to ≤6.0 parts by weight, particularly preferably from ≥1.0 to ≤5.0 parts by weight, where all parts by weight of the component K are based on the sum of the parts by weight of the components A1+A2=100 parts by weight.

In a fourth embodiment, the invention provides a process according to any of the embodiments 1 to 3, wherein
B1 catalysts such as
   a) aliphatic tertiary amines, cycloaliphatic tertiary amines, aliphatic amino ethers, cycloaliphatic amino ethers, aliphatic amidines, cycloaliphatic amidines, urea and derivatives of urea and/or
   b) tin(II) salts of carboxylic acids and
B2 optionally auxiliaries and additives
are used as component B.

In a fifth embodiment, the invention provides a process according to any of the embodiments 1 to 3, wherein
B1 catalysts and
B2 optionally auxiliaries and additives
are used as component B,
where the following are used as component B 1:
B1.1 from ≥0.05 to ≤1.5 parts by weight, based on the sum of the parts by weight of the components A1 and A2, of urea and/or derivatives of urea and
B1.2 from ≥0.03 to ≤1.5 parts by weight, based on the sum of the parts by weight of components A1 and A2, of catalysts other than those of the component B1.2, with the content of amine catalysts in the component B1.2 being not more than 50% by weight based on component B1.

In a sixth embodiment, the invention provides a process according to any of the embodiments 2 to 5, wherein component A is free of components A3 and/or A4.

In a seventh embodiment, the invention provides a process according to any of the embodiments 1 to 6, wherein component A comprises:
A1 from ≥65 to ≤75 parts by weight of one or more polyether carbonate polyols having a hydroxyl number in accordance with DIN 53240-1 (June 2013) of from ≥20 mg KOH/g to ≤120 mg KOH/g, and
A2 from ≤35 to ≥25 parts by weight of one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, with the polyether polyols A2 being free of carbonate units.

In an eighth embodiment, the invention provides a process according to any of the embodiments 1 to 7, wherein component A1 comprises a polyether carbonate polyol which is obtainable by copolymerization of carbon dioxide and one or more alkylene oxides in the presence of one or more H-functional starter modules, with the polyether carbonate polyol preferably having a CO₂ content of from 15 to 25% by weight.

In a ninth embodiment, the invention provides a process according to any of the embodiments 1 to 8, wherein component K is selected from among one or more compounds of the group consisting of
K1 dicarbonyl compounds of the formula (II), excluding dicarbonyl compounds that are esters of mono- or polybasic carboxylic acids,

(R²)ₓ—(C═O)—(R¹)ₙ—(C═O)—(R³)_{y} (II)
where
n is 1, 2 or 4, preferably 1 or 2,
x, y may be the same or different and are 1 or 2,
R¹ may be the same or different and is substituted or unsubstituted C1-C22-alkylene, substituted or unsubstituted C6-C18-arylene or heteroarylene,
R², R³ may be the same or different and are substituted or unsubstituted C1-C22-alkyl, amine, amide or hydroxyl,
K2 β-keto nitriles of the formula (III)

(R⁵)_{w}—(C═O)—C(H)(R⁴)(—CN) (III)
where
w is 1 or 2,
R⁴ is H,
R⁵ may be the same or different and is amine, amide or acyl,
K3 dicarbonyl compounds having the formula (IV)

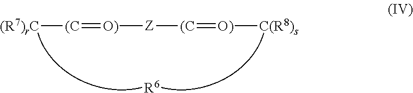

where
Z is —O— or —N(R⁹)—,
r, s are 1 or 2, where
   r and s are 2 when R⁶ is a single bond or —C(R⁹)₂—,
   r is 1 and s is 2 when R⁶ is ═C(H)—,
   r is 2 and s is 1 when R⁶ is ═C(H)—,
   r and s are 1 when R⁶ is a double bond,
R⁶ is a single bond, double bond, —C(R⁹)₂— or ═C(H)—,
R⁷, R⁸ may be the same or different and are H, substituted or unsubstituted C1-C22-alkyl, substituted or unsubstituted C1-C22-alkenyl, substituted or unsubstituted C6-C18-aryl, or heteroaryl, or are parts of a 4- to 7-membered ring or polycyclic system,
R⁹ is H, substituted or unsubstituted C1-C22-alkyl, substituted or unsubstituted C1-C22-alkenyl, substituted or unsubstituted C6-C18-aryl, heteroaryl or hydroxyl,
K4 one or more compounds selected from the group comprising α-hydroxycarboxylic acids and β-hydroxycarboxylic acids,
K5 carboxylic salts, i.e. compounds of carboxylate anion and cation, where the cation is an ammonium-based compound)N(H)ₒ(R¹⁰)ₚ where o and p are an integer of 0 to 4, o+p=4, and where R¹⁰ is substituted or unsubstituted C1-C22-alkyl, substituted or unsubstituted C1-C22-alkenyl, substituted or unsubstituted C6-C18-aryl.

In a tenth embodiment, the invention provides a process according to any of the embodiments 1 to 8, wherein
K1 is selected from one or more compounds from the group consisting of succinic acid, thiophene-2,5-dicarboxylic acid, malonamide, acetoacetamide, N,N-dimethylacetoacetamide, acetylacetone, 5,5-dimethyl-1,3-cyclohexanedione, terephthalic acid, oxalamide, diacetylhydrazine, adipic acid, maleic acid or citraconic acid,
K2 is selected from one or more compounds from the group consisting of cyanoacetohydrazide, N-benzyl-2-cyanoacetamide, cyanoacetamide, 2-amino-2-cyanoacetamide, N-tert-butyl-2-cyanoacetamide or cyanoacetylurea,
K3 is selected from one or more compounds from the group consisting of phthalic anhydride, 1,2,3,6-tetrahydrophthalic anhydride, N-hydroxyphthalimide, dodecenylsuccinic anhydride, maleic anhydride or citraconic anhydride.

In an eleventh embodiment, the invention provides a process according to any of the embodiments 1 to 10, wherein a component B which contains at least one tin(II) salt of the formula (IX)

Sn(CₓH₂ₓ₊₁COO)₂ (IX)

where x is an integer from 8 to 24, preferably from 10 to 20, particularly preferably from 12 to 18, is used.

In a twelfth embodiment, the invention provides a process according to any of the embodiments 1 to 11, wherein 2, 4- and/or 2,6-TDI is used as isocyanate component in component D.

In a thirteenth embodiment, the invention provides polyurethane foams obtainable by a process according to any of the embodiments 1 to 12.

In a fourteenth embodiment, the invention provides polyurethane foams according to the thirteenth embodiment, wherein the foams are flexible polyurethane foams.

In a fifteenth embodiment, the invention provides for the use of the polyurethane foams according to embodiment 13 or 14 for producing furniture upholstery, textile inserts, mattresses, automobile seats, headrests, armrests, sponges, foam sheets for use in automobile components such as roof liners, door trim, seat cushions and components.

### EXAMPLES

### Test Methods

Experimentally determined OH numbers (hydroxyl number) were determined by the method of DIN 53240-1 (June 2013).

### Determination of Emissions—Cyclic Propylene Carbonate

The cPC content was quantified by means of NMR spectroscopy (Bruker, DPX 400, 400 MHz): about 24 h after production of the flexible polyurethane foams, a sample of 1.2-1.5 g of the flexible polyurethane foam was extracted at 60° C. in acetone using a Soxhlet apparatus for 7.5 hours. The extract was concentrated under reduced pressure and taken up in deuterated chloroform, with dimethyl terephthalate or 1,2,4-trichlorobenzene as internal standard. Subsequently, the cPC content was quantified by NMR by comparison with the internal standard.

The present invention will be illustrated with the aid of the following examples, but without being restricted thereto. The abbreviations mean:
A1-1: Polyether carbonate polyol, functionality 2.8, OH number 54 mg KOH/g, 14% by weight of CO₂, prepared by copolymerization of propylene oxide and carbon dioxide with glycerol and propylene glycol as H-functional starter compounds in the presence of a double metal cyanide catalyst
B1-1: Niax Catalyst A-1, commercial product from Momentive Performance Materials GmbH, bis[2-(N,N′-dimethylamino)ethyl]-based
B1-2: Desmorapid SO, tin catalyst (from Covestro AG)
B2-1: Tegostab BF 2370, commercial product from Evonik Industries
B2-2: Niax Silicone L-620, commercial product from Momentive Performance Materials GmbH
C-1: Water
D-1: Desmodur T 80, mixture of tolylene 2,4′-diisocyanate and tolylene 2,6′-diisocyanate in a ratio of 80/20 (from Covestro AG)
K1-1: Acetoacetamide (from Sigma-Aldrich)
K1-2: Terephthalic acid (from Sigma-Aldrich)
K1-3: Adipic acid (from Sigma-Aldrich)
K1-4: Malonamide (from Sigma-Aldrich)
K2-2: Cyanoacetamide (from abcr GmbH)
K3-1: 1,2,3,6-Tetrahydrophthalic anhydride (from Merck KGaA)
K3-2: N-Hydroxyphthalimide (from Sigma-Aldrich)
K3-3: Dodecenylsuccinic anhydride (from Sigma-Aldrich)
K4-1: Malic acid (from Sigma-Aldrich)
K5-1: Ammonium tartrate (from Sigma-Aldrich)
Fyrol-PNX: oligomeric alkyl phosphate (from ICL-IP)

### Production of Laboratory Flexible Foams:

The flexible polyurethane foams described in Table 1 were produced in a batchwise process. The components were mixed by means of a Pendraulik LM 34 laboratory mixer.

Component A1-1 (125 g) was weighed out in a 500 mL paper cup together with components B1-1, B2-1 and C-1 and premixed with a high-speed stirrer for 10 seconds. This was followed by the addition of component B1-2 and mixing at the same stirrer speed for 10 seconds. Finally, component D-1 was added to this mixture, which was mixed for 7 seconds, and the mixture was transferred to a prepared paper box having dimensions of 20 cm×20 cm×15 cm.

The height of the flexible polyurethane foam blocks was about 14-15 cm. The finished flexible polyurethane foam was stored in the paper box for about 20-24 hours before being sawn into specimens for testing. The compressive strength and foam density of the flexible polyurethane foams were determined in accordance with DIN EN ISO 3386-1-98.

In the case of use of a component K, it was first preliminarily stirred in component A1-1 before the rest of the formulation components were added as described above.

### Production of Laboratory Flexible Box-Molded Foams

The flexible polyurethane foams described in Table 2 were produced in a batchwise process. For this purpose, in a 5 L bucket, component A1-1 (2000 g) was weighed out together with components B1-1, B2-2 and C-1 and premixed with a high-speed stirrer for 20 seconds. This was followed by the addition of component B1-2 and mixing at the same speed for 10 seconds. Finally, component D-1 was added to this mixture, which was mixed for a further 7 seconds, and the mixture was transferred to a prepared paper box having dimensions of 50 cm×50 cm×50 cm.

The height of the flexible polyurethane foam blocks was about 50-55 cm. The finished flexible polyurethane foam was stored in the paper box for about 20-24 hours before being sawn into specimens for testing. The compressive strength and foam density of the flexible polyurethane foams were determined in accordance with DIN EN ISO 3386-1-98.

In the case of use of a component K, it was first preliminarily stirred in component A1-1 before the rest of the formulation components were added as described above.

### Results

### a) Laboratory Flexible Foams (Table 1)

Without component K, the resulting flexible polyurethane foam showed high emission of cyclic propylene carbonate (Comparative Example 1); with use of a P—O-containing compound, this emission can be reduced (Comparative Example 2). Surprisingly, the addition of a component K, however, results in lower values for cyclic propylene carbonate across the board in the determination of emissions (Examples 3 to 15) by comparison with Comparative Examples 1 and 2.

Surprisingly, even a very small addition of starting from 0.05 parts by weight of component K, based on 100 parts by weight of component A1-1, leads to a reduction in the emission of cyclic propylene carbonate, as shown, for example, by the comparison of Examples 7, 8 and with Comparative Examples 1 and 2 (Table 1).

### b) Laboratory Flexible Box-Molded Foams (Table 2)

Without component K, the resulting flexible polyurethane foam showed high emission of cyclic propylene carbonate (Comparative Example 16), finding a higher emission level of cyclic propylene carbonate compared to the laboratory flexible foam produced on a smaller scale (Comparative Example 1). With use of a P—O-containing compound, this emission can be reduced (Comparative Example 17). Surprisingly, the addition of an inventive component K, however, results in much lower values for cyclic propylene carbonate across the board in the determination of emissions (Examples 18 to 21) by comparison with Comparative Examples 16 and 17.

Surprisingly, even a very small addition of starting from 0.05 parts by weight of component K, based on 100 parts by weight of component A1-1, leads to a reduction in the emission of cyclic propylene carbonate, as shown by Examples 18 and 20 by comparison with Comparative Examples 16 and 17 (Table 2).

TABLE 1
Laboratory flexible foam

| COMPONENT\Example | | 1 (comp.) | 2 (comp.) | 3 | 4 | 5 | 6 |
|---|---|---|---|---|---|---|---|
| A1-1 | [pts. by wt.] | 100 | 100 | 100 | 100 | 100 | 100 |
| B1-1 | [pts. by wt.] | 0.12 | 0.12 | 0.12 | 0.12 | 0.12 | 0.12 |
| B1-2 | [pts. by wt.] | 0.18 | 0.18 | 0.18 | 0.18 | 0.18 | 0.18 |
| B2-1 | [pts. by wt.] | 1.20 | 1.20 | 1.20 | 1.20 | 1.20 | 1.20 |
| C-1 | [pts. by wt.] | 4.50 | 4.50 | 4.50 | 4.50 | 4.50 | 4.50 |
| Fyrol-PNX | [pts. by wt.] | — | 2.0 | — | — | — | — |
| K1-1 | [pts. by wt.] | — | — | 2.0 | — | — | — |
| K1-2 | [pts. by wt.] | — | — | — | 2.0 | — | — |
| K2-1 | [pts. by wt.] | — | — | — | — | 2.0 | — |
| K3-1 | [pts. by wt.] | — | — | — | — | — | 2.0 |
| D-1 | [pts. by wt.] | 56.01 | 56.01 | 56.01 | 56.01 | 56.01 | 56.01 |
| Index | | 108 | 108 | 108 | 108 | 108 | 108 |
| Foam density | kg m⁻³ | 27.86 | 27.83 | 30.37 | 25.92 | 24.03 | 25.28 |
| Compressive strength at 40% | kPa | 5.02 | 6.22 | 8.25 | 4.08 | 5.29 | 4.54 |
| compression (4th cycle) | | | | | | | |
| Cycl. propylene carbonate | [mg/kg] | 92 | 13 | 6 | 7 | 8 | 3 |

| COMPONENT\Example | | 7 | 8 | 9 | 10 | 11 | 12 | 13 | 14 | 15 |
|---|---|---|---|---|---|---|---|---|---|---|
| A1-1 | [pts. by wt.] | 100 | 100 | 100 | 100 | 100 | 100 | 100 | 100 | 100 |
| B1-1 | [pts. by wt.] | 0.12 | 0.12 | 0.12 | 0.12 | 0.12 | 0.12 | 0.12 | 0.12 | 0.12 |
| B1-2 | [pts. by wt.] | 0.18 | 0.18 | 0.18 | 0.18 | 0.18 | 0.18 | 0.18 | 0.18 | 0.18 |
| B2-1 | [pts. by wt.] | 1.20 | 1.20 | 1.20 | 1.20 | 1.20 | 1.20 | 1.20 | 1.20 | 1.20 |
| C-1 | [pts. by wt.] | 4.50 | 4.50 | 4.50 | 4.50 | 4.50 | 4.50 | 4.50 | 4.50 | 4.50 |
| Fyrol-PNX | [pts. by wt.] | — | — | — | — | — | — | — | — | — |
| K1-3 | [pts. by wt.] | 0.08 | — | — | — | — | — | — | — | — |
| K1-4 | [pts. by wt.] | — | 0.8 | 3.5 | 5.5 | — | — | — | — | — |
| K3-2 | [pts. by wt.] | — | — | — | — | — | — | — | 1.0 | — |
| K3-3 | [pts. by wt.] | — | — | — | — | 1.5 | 3.5 | — | — | — |
| K4-1 | [pts. by wt.] | — | — | — | — | — | — | — | — | 0.08 |
| K5-1 | [pts. by wt.] | — | — | — | — | — | — | 1.0 | — | — |
| D-1 | [pts. by wt.] | 56.01 | 56.01 | 56.01 | 56.01 | 56.01 | 56.01 | 56.01 | 56.01 | 56.01 |
| Index | | 108 | 108 | 108 | 108 | 108 | 108 | 108 | 108 | 108 |
| Foam density | kg m⁻³ | 27.68 | 25.76 | 24.08 | 25.50 | 24.93 | 24.38 | 25.09 | 23.67 | 28.77 |
| Compressive strength at 40% | kPa | 6.83 | 4.55 | 5.00 | 4.58 | 5.09 | 5.28 | 5.75 | 6.20 | 6.68 |
| compression (4th cycle) | | | | | | | | | | |
| Cycl. propylene carbonate | [mg/kg] | 6 | 7 | 6 | 9 | 11 | 2 | 10 | 9 | 7 |

TABLE 2
Laboratory flexible box-molded foam

| COMPONENT\Example | | 16 (comp.) | 17 (comp.) | 18 | 19 | 20 | 21 |
|---|---|---|---|---|---|---|---|
| A1-1 | [pts. by wt.] | 2000 | 2000 | 2000 | 2000 | 2000 | 2000 |
| B1-1 | [pts. by wt.] | 2.4 | 2.4 | 2.4 | 2.4 | 2.4 | 2.4 |
| B1-2 | [pts. by wt.] | 3.6 | 3.6 | 3.6 | 3.6 | 3.6 | 3.6 |
| B2-2 | [pts. by wt.] | 24 | 24 | 24 | 24 | 24 | 24 |
| C-1 | [pts. by wt.] | 90 | 90 | 90 | 90 | 90 | 90 |
| Fyrol-PNX | [pts. by wt.] | — | 40 | — | — | — | — |
| K1-4 | [pts. by wt.] | — | — | 16 | — | — | — |
| K2-1 | [pts. by wt.] | — | — | — | 40 | — | — |
| K2-2 | [pts. by wt.] | — | — | — | — | 16 | — |
| K3-1 | [pts. by wt.] | — | — | — | — | — | 40 |
| D-1 | [pts. by wt.] | 1120 | 1120 | 1120 | 1120 | 1120 | 1120 |
| Index | | 108 | 108 | 108 | 108 | 108 | 108 |
| Foam density | kg m⁻³ | 22.0 | 22.6 | 21.3 | 21.5 | 21.8 | 21.6 |
| Compressive strength at 40% | kPa | 4.15 | 5.43 | 3.69 | 3.69 | 3.89 | 3.3 |
| compression (4th cycle) | | | | | | | |
| Cycl. propylene carbonate | [mg/kg] | 558 | 142 | 17 | 9 | 20 | 12 |

1. A process for producing polyurethane foams by reaction of:
component A comprising:
A1 polyether carbonate polyol having a hydroxyl number in accordance with DIN 53240-1 (June 2013) of from ≥20 mg KOH/g to ≤120 mg KOH/g and
A2 optionally one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, with the polyether polyols A2 being free of carbonate units,
B optionally
B1) catalysts, and/or
B2) auxiliaries and additives
C water and/or physical blowing agents,
with
D di- and/or polyisocyanates,
wherein the production is effected at an index of from ≥90 to ≤120, wherein the production reaction is effected in the presence of a component K, wherein component K is selected from one or more compounds from the group consisting of;
K1 dicarbonyl compounds of the formula (II), excluding dicarbonyl compounds that are esters of mono- or polybasic carboxylic acids,
(R²)ₓ—(C═O)—(R¹)ₙ—(C═O)—(R³)_{y} (II),
wherein
n is an integer of ≥0 to ≤6,
x, y may be the same or different and are an integer of ≥1 to ≤3,
R¹ may be the same or different and is substituted or unsubstituted C1-C22-alkylene, substituted or unsubstituted C1-C22-alkenylene, substituted or unsubstituted C6-C18-arylene, heteroarylene, amines or amides, or is part of a 4- to 7-membered ring or polycyclic system,
R², R³ may be the same or different and are H, substituted or unsubstituted C1-C22-alkyl, substituted or unsubstituted C1-C22-alkenyl, substituted or unsubstituted C6-C18-aryl, heteroaryl, amine, amide, hydroxyl or nitrile, or are parts of a 4- to 7-membered ring or polycyclic system,
K2 β-keto nitriles of the formula (III)
(R⁵)_{w}—(C═O)—C(H)(R⁴)(—CN) (III)
wherein
w is an integer of ≥1 to ≤3,
R⁴ is H, substituted or unsubstituted C1-C22-alkyl, substituted or unsubstituted C1-C22-alkenyl, substituted or unsubstituted C6-C18-aryl, heteroaryl, amine or amide, or is part of a 4- to 7-membered ring or polycyclic system,
R⁵ may be the same or different and is H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or is part of a 4- to 7-membered ring or polycyclic system,
K3 dicarbonyl compounds having the formula (IV), 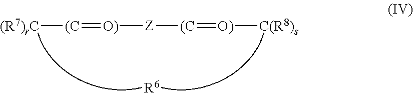
wherein
Z is —O—, —N(R⁹)—, or C1-C6-alkylene,
r, s are 1 or 2, wherein
r and s are 2 when R⁶ is a single bond, —C(R⁹)₂—, —O—, or —N(R⁹)—,
r is 1 and s is 2 when R⁶ is ═C(H)—,
r is 2 and s is 1 when R⁶ is ═C(H)—,
r and s are 1 when R⁶ is a double bond,
R⁶ is a single bond, double bond, —C(R⁹)₂—, ═C(H)—, —O—, or —N(R⁹)—,
R⁷, R⁸ may be the same or different and is H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or are parts of a 4- to 7-membered ring or polycyclic system,
R⁹ is H, substituted or unsubstituted C1-C22-alkyl, substituted or unsubstituted C1-C22-alkenyl, substituted or unsubstituted C6-C18-aryl, heteroaryl, acyl, amine, amide, hydroxyl or nitrile, or is part of a 4- to 7-membered ring or polycyclic system,
K4 hydroxycarboxylic acids, and
K5 carboxylic salts, wherein the cation is Li⁺, Na⁺, K⁺, Rb⁺, Cs⁺, Be²⁺, Mg²⁺, Ca²⁺, Sr²⁺, Ba²⁺, or an ammonium-based compound)N(H)ₒ(R¹⁰)ₚ, wherein o and p are an integer from 0 to 4 and o+p=4 and wherein R¹⁰ is substituted or unsubstituted C1-C22-alkyl, substituted or unsubstituted C1-C22-alkenyl, substituted or unsubstituted C6-C18-aryl,
and wherein component K is used in an amount of from ≥0.05 to 10.0 parts by weight, wherein all parts by weight of the component K are based on the sum of the parts by weight of the components A1+A2=100 parts by weight.

2. The process as claimed in claim 1, wherein component A has the following composition:
A1 from ≥40 to ≤100 parts by weight of one or more polyether carbonate polyols having a hydroxyl number in accordance with DIN 53240-1 (June 2013) of from ≥20 mg KOH/g to ≤120 mg KOH/g,
A2 from ≤60 to ≥0 parts by weight of one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, with the polyether polyols A2 being free of carbonate units,
A3 from ≤20 to ≥0 parts by weight, based on the sum of the parts by weight of the components A1 and A2, of one or more polyether polyols having a hydroxyl number in accordance with DIN 53240-1 (June 2013) of from ≥20 mg KOH/g to ≤250 mg KOH/g and a content of ethylene oxide of >60% by weight, with the polyether polyols A3 being free of carbonate units,
A4 from ≤40 to ≥0 parts by weight, based on the sum of the parts by weight of the components A1 and A2, of one or more polymer polyols, PUD polyols and/or PIPA polyols, and
A5 from ≤40 to ≥0 parts by weight, based on the sum of the parts by weight of the components A1 and A2, of polyols which do not come under the definition of the components A1 to A4,
wherein all parts by weight of the components A1, A2, A3, A4, A5 are normalized so that the sum of the parts by weight of A1+A2 in the composition is 100.

3. The process as claimed in claim 1, wherein component K is used in an amount of from ≥0.5 to ≤6.0 parts by weight, and wherein all parts by weight of the component K are based on the sum of the parts by weight of the components A1+A2=100 parts by weight.

4. The process as claimed in claim 1, wherein
B1 catalysts
a) aliphatic tertiary amines, cycloaliphatic tertiary amines, aliphatic amino ethers, cycloaliphatic amino ethers, aliphatic amidines, cycloaliphatic amidines, urea and derivatives of urea and/or
b) tin(II) salts of carboxylic acids and
B2 optionally auxiliaries and additives
are used as component B.

5. The process as claimed in claim 1, wherein
B1 catalysts and
B2 optionally auxiliaries and additives
are used as component B,
wherein the following are used as component B1:
B1.1 from ≥0.05 to ≤1.5 parts by weight, based on the sum of the parts by weight of the components A1 and A2, of urea and/or derivatives of urea and
B1.2 from ≥0.03 to ≤1.5 parts by weight, based on the sum of the parts by weight of components A1 and A2, of catalysts other than those of the component B1.2, with the content of amine catalysts in the component B1.2 being not more than 50% by weight based on component B1.

6. The process as claimed in claim 2, wherein component A is free of components A3 and/or A4.

7. The process as claimed in claim 1, wherein component A comprises:
A1 from ≥65 to ≤75 parts by weight of one or more polyether carbonate polyols having a hydroxyl number in accordance with DIN 53240-1 (June 2013) of from ≥20 mg KOH/g to ≤120 mg KOH/g, and
A2 from ≤35 to ≥25 parts by weight of one or more polyether polyols having a hydroxyl number in accordance with DIN 53240-1 (June 2013) of from ≥20 mg KOH/g to ≤250 mg KOH/g and a content of ethylene oxide of from ≥0 to ≤60% by weight, with the polyether polyols A2 being free of carbonate units.

8. The process as claimed in claim 1, wherein component A1 comprises a polyether carbonate polyol which is obtainable by copolymerization of carbon dioxide and one or more alkylene oxides in the presence of one or more H-functional starter molecules.

9. The process as claimed in claim 1, wherein component K is selected from one or more compounds of the group consisting of:
K1 dicarbonyl compounds of the formula (II), excluding dicarbonyl compounds that are esters of mono- or polybasic carboxylic acids,
(R²)ₓ—(C═O)—(R¹)ₙ—(C═O)—(R³)_{y} (II)
wherein
n is 1, 2 or 4, preferably 1 or 2,
x, y may be the same or different and are 1 or 2,
R¹ may be the same or different and is substituted or unsubstituted C1-C22-alkylene, substituted or unsubstituted C6-C18-arylene, or heteroarylene,
R², R³ may be the same or different and are substituted or unsubstituted C1-C22-alkyl, amine, amide, or hydroxyl,
K2 β-keto nitriles of the formula (III)
(R⁵)_{w}—(C═O)—C(H)(R⁴)(—CN) (III)
wherein
w is 1 or 2,
R⁴ is H,
R⁵ may be the same or different and is amine, amide or acyl,
K3 dicarbonyl compounds having the formula (IV) 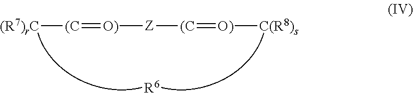
wherein
Z is —O— or —N(R⁹)—,
r, s are 1 or 2, where
r and s are 2 when R⁶ is a single bond or —C(R⁹)₂—,
r is 1 and s is 2 when R⁶ is ═C(H)—,
r is 2 and s is 1 when R⁶ is ═C(H)—,
r and s are 1 when R⁶ is a double bond,
R⁶ is a single bond, double bond, —C(R⁹)₂—, or ═C(H)—,
R⁷, R⁸ may be the same or different and are H, substituted or unsubstituted C1-C22-alkyl, substituted or unsubstituted C1-C22-alkenyl, substituted or unsubstituted C6-C18-aryl, or heteroaryl, or are parts of a 4- to 7-membered ring or polycyclic system,
R⁹ is H, substituted or unsubstituted C1-C22-alkyl, substituted or unsubstituted C1-C22-alkenyl, substituted or unsubstituted C6-C18-aryl, or heteroaryl or hydroxyl,
K4 one or more compounds selected from the group comprising α-hydroxycarboxylic acids and 3-hydroxycarboxylic acids, and
K5 carboxylic salts, wherein the cation is an ammonium-based compound)N(H)ₒ(R¹⁰)ₚ wherein o and p are an integer of 0 to 4 and o+p=4, and wherein R¹⁰ is substituted or unsubstituted C1-C22-alkyl, substituted or unsubstituted C1-C22-alkenyl, or substituted or unsubstituted C6-C18-aryl.

10. The process as claimed in claim 1, wherein
K1 is selected from one or more compounds from the group consisting of succinic acid, thiophene-2,5-dicarboxylic acid, malonamide, acetoacetamide, N,N-dimethylacetoacetamide, acetylacetone, 5,5-dimethyl-1,3-cyclohexanedione, terephthalic acid, oxalamide, diacetylhydrazine, adipic acid, maleic acid, and citraconic acid,
K2 is selected from one or more compounds from the group consisting of: cyanoacetohydrazide, N-benzyl-2-cyanoacetamide, cyanoacetamide, 2-amino-2-cyanoacetamide, N-tert-butyl-2-cyanoacetamide and cyanoacetylurea,
K3 is selected from one or more compounds from the group consisting of: phthalic anhydride, 1,2,3,6-tetrahydrophthalic anhydride, N-hydroxyphthalimide, dodecenylsuccinic anhydride, maleic anhydride, and citraconic anhydride.

11. The process as claimed in claim 1, wherein component B comprises at least one tin(II) salt of the formula (IX)
Sn(CₓH₂ₓ₊₁COO)₂ (IX)
wherein x is an integer from 8 to 24.

12. The process as claimed in claim 1, wherein 2,4- and/or 2,6-TDI is used as an isocyanate component in component D.

13. A polyurethane foam obtainable by the process as claimed in claim 1.

14. The polyurethane foam as claimed in claim 13, wherein the polyurethane foam is a flexible polyurethane foam.

15. Furniture upholstery, a textile insert, a mattress, an automobile seat, a headrest, an armrest, a sponge, or a foam sheet for use in automobile components comprising the polyurethane foam as claimed in claim 13.

16. The process of claim 1, wherein n of formula (II) is an integer of ≥1 to ≤4.

17. The process of claim 1, wherein K4 is α-hydroxybenzoic acid, malic acid, or tartaric acid.

18. The process of claim 1, wherein the cation of K5 is an ammonium-based compound N(H)ₒ(R¹⁰)ₚ.

19. The process of claim 1, wherein the cation of K5 is an ammonium-based compound selected from one or more ammonium-based compounds from the group consisting of: NH₄⁺, (NR¹⁰₄)⁺, and (NR¹⁰₃H)⁺.

20. The process as claimed in claim 9, wherein n of formula (II) is 1 or 2.
